(19) United States
(12) Patent Application Publication
(10) Pub. No.: US 2006/0026328 A1
(43) Pub. Date: Feb. 2, 2006

(54) Apparatus And Related Method For Calculating Parity of Redundant Array Of Disks

(76) Inventor: Yong Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/908,237

(22) Filed: May 4, 2005

(30) Foreign Application Priority Data
Jul. 27, 2004 (TW) 093122448

(51) Int. Cl. G06F 13/36

(52) U.S. Cl. 710/306

(57) ABSTRACT

For error tolerance in a redundant array disks (RAID), a parity data is calculated according to plurality of data respectively accessed in disks of the RAID. A hardware calculation module for parity calculation can be implemented in a RAID controller. With direct memory access (DMA) capability of the RAID controller, the calculation module performs parity calculation by directly accessing a system memory for the plurality of data and the parity data. Thus, memory resources of the parity calculation can be supported by the system memory, and a central processing unit (CPU) can be offloaded during parity calculation.

### BACKGROUND OF THE INVENTION

1. Field of the Invention

The invention relates to an apparatus and a related method for implementing parity calculation of a redundant array of disks (RAID), more particularly, to an apparatus and a related method for implementing a hardware calculation module for parity calculation by directly accessing a system memory.

2. Description of the Prior Art

A computer system is an essential piece of hardware in modern society. In order to calculate and manage all kinds of electronic information, figures and data, all computer systems have a hard disk as a storage device for nonvolatile random access to data, documents and multimedia files. The size, speed and safety in accessing large amounts of information are the main points manufacturers are concerned with.

With increasing hard disk capacity and low price, the modern computer system is capable of implementing RAID wherein multiple disks are merged to operate together, increasing efficiency of data access and error tolerance. As known by those skilled in the art, in accordance with different data structures, the architecture of RAID is split into different categories such as RAID 0, RAID 1, RAID 0+1, RAID 2 to RAID 5. RAID 3 to RAID 5 each use XOR (exclusive OR) logic to generate a parity checking code to achieve error tolerance. For example, in RAID 5 which consists of two disks, data is entered and split into two component data each stored into different disk. At the same time, the XOR logic operation is performed on the data to generate a corresponding parity checking data; this parity checking data is also stored in the array of disks. When one hard disk fails, according to the parity checking data of the other disk and the data left on first disk, it is still possible to retrieve the original information, hence the error tolerance is achieved.

In accessing the array of disks (especially in RAID 3 to 5), the XOR logic of the parity calculation needs to be performed frequently in order to provide sufficient error tolerance. As known by those skilled in the art, this type of parity calculation is achieved by either software or hardware technology. As for hardware, in the current technology process hardware for the parity calculation is installed in the RAID controller, and a memory is added specifically to support the memory resources needed. The known RAID controller also needs corresponding hardware to manage data access of the memory, such as a decoder. Thus, complicated components, high cost, high resource demand, high heat output, and a large circuit area of the RAID controller make it unsuitable for built-in motherboards and chipsets. It is only suitable in the form of an interface card.

Furthermore, for software performing a parity calculation, the central processing unit is needed to execute the software to perform the XOR operation. It is obvious that the current technology increases operation workload and hence decreases system operation efficiency.

### SUMMARY OF THE INVENTION

It is therefore a primary objective of the claimed invention to address a technique of utilizing direct memory access capability of the hardware parity calculation, to solve the above-mentioned problems.

The claimed invention uses hardware of the RAID controller to perform a parity calculation, furthermore, a mechanism of the direct memory access of the RAID controller allows the RAID controller to gain direct access into the system memory to support the memory resources needed by the parity calculation. By not using the central processing unit, the claimed invention can perform the hardware parity calculation with a faster speed and a higher efficiency. Also there is no need to install a special memory and related circuit into the RAID controller. Thus in the claimed invention, the RAID controller has qualities like simplified components, low cost, low resource demand, and low heat output, and is capable of either being installed as a interface card, or built-in to motherboards or chipsets.

Generally speaking, in modern computer components, the chipset is coupled in between to the central processing unit and the system memory. Peripheral device controllers such as an integrated device electronics (IDE) controller or a RAID controller, can all be integrated in a chipset or through a peripheral component interconnect bus (PCI), which is coupled with the chipset. In order to reduce the workload of the central processing unit, these controllers can launch a bus master to perform the direct memory access via the north bridge of the chipset, directly accessing the data of the system memory. To coordinate the assignment of direct memory access of the controller, there are registers set within the controller for registering data such as pointers and status that are needed by the direct memory access.

For example, the register of the controller comprises a register of a descriptor table pointer and a status register representing assignment condition of the direct memory access. When the controller begins a bus master and directly accesses the data of the system memory, the address of data in the system memory is recorded as physical region descriptor table (PRDT), and the central processing unit is capable of executing a corresponding software (like a driver) for storing a PRDT pointer to a corresponding register of a controller. The descriptor table pointer records the address of the description table in the system memory. Then the controller performs a direct memory access, by finding the description table in the system memory according to the descriptor table pointer and then the controller accesses the corresponding data according to the description table.

Other than the mechanism of descriptor table pointer and description table, the status register is able to respond to the performing condition of the direct memory access. To achieve data synchronization, in the modern architecture of direct memory access, if the central processing unit executes software to access the status data temporarily stored in the status register, the controller will complete the accessing process of the system memory before responding the status data. In another words, after the central processing unit accesses the status register, if a status data response is received from the controller, then it means the controller has completed a direct memory access; hence this type of mechanism becomes a channel for the controller responding to the software control.

To achieve the objective of the claimed invention, these related mechanisms of direct memory access could be utilized. In the claimed invention, the hardware of parity calculation is installed in the RAID controller, also by utilizing the mechanism of descriptor table pointers and description tables, the controller can access each data to perform a parity calculation. After performing the hardware parity calculation, the invention can also utilize the mechanism of descriptor table pointers and description tables to store the result of the parity calculation back to the system memory. In another words, the hardware of the parity calculation of the RAID controller can directly utilize the system memory to support the memory resources needed by the parity calculation. The RAID controller is able perform the hardware parity calculation through the simplified components of the claimed invention. In the claimed invention, there are three ways to utilize the mechanism of descriptor table pointers and description tables for the controller to access each data needed to perform a parity calculation, and to store the result of the parity calculation back into the system memory.

Furthermore, the invention can also utilize a mechanism of the status register of the RAID controller to provide a software response channel for the hardware parity calculation . The central processing unit executes the software driver of the RAID controller and utilizes the hardware of the controller to perform a parity calculation, the central processing unit only needs to access the status register of the controller to perform the hardware parity calculation. The parity calculation has to be completed and the results has to be stored back to the system memory before the status data of the status register response is sent to the central processing unit. In another words, if the software of the driver receives the status data response of the controller, it means that the RAID controller has completed a hardware parity calculation.

In performing the hardware parity calculation, the claimed invention bypasses the central processing unit as the RAID controller uses simplified, low cost, and low resource-consuming components to achieve a fast and efficient hardware parity calculation to support all related operations of the RAID.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to the present invention.

FIG. 2 illustrates how a parity calculation is implemented in the computer system of FIG. 1 according to the first embodiment.

FIG. 3 illustrates how a parity calculation is implemented in the computer system of FIG. 1 according to the second embodiment.

FIG. 4 illustrates how a parity calculation is implemented in the computer system of FIG. 1 according to the third embodiment.

FIG. 5 illustrates a flowchart of the computer system of FIG. 1 implementing a mechanism of direct memory access to perform a hardware parity calculation.

### DETAILED DESCRIPTION

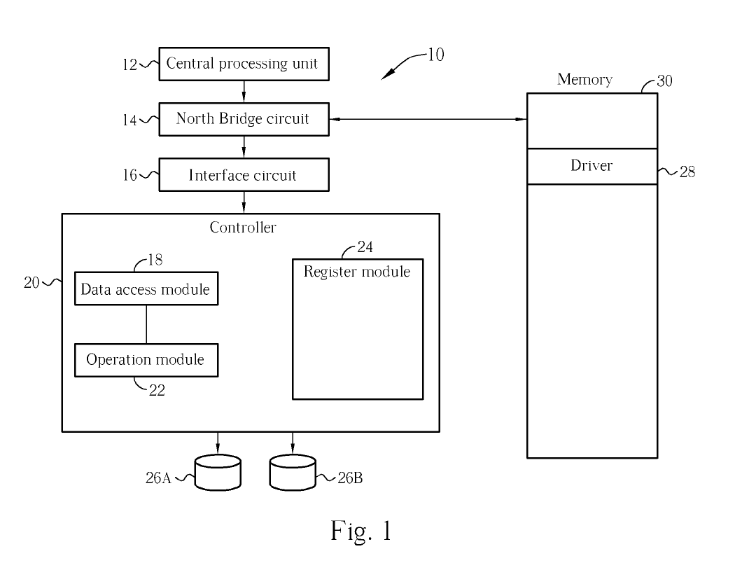

Please refer to FIG. 1, which illustrates a computer system 10 comprising a central processing unit 12 for controlling the computer system 10, a north bridge 14, an interface circuit 16, a memory 30 and a controller 20. The memory 30 of the system memory is a dynamic random access memory for supporting memory resources needed by the central processing unit 12. The north bridge 14, is coupled in between the central processing unit 12 and the memory 30, manages the data access of the memory 30. The controller 20 can be a RAID controller via a bus, such as an advanced technology attachment (ATA) or ATA packet interface (ATAPI) bus, a serial ATA bus or a small computer system interface (SCSI) bus, coupled to a plurality of storage devices (in FIG. 1, HD(1) to HD(M) represent hard disks) to combine to form a RAID which manages data access. The interface circuit 16 is coupled in between the north bridge 14 and the controller 20. For example, if the controller 20 is integrated in a south bridge, the interface circuit 16 can be another circuit in the south bridge, and hence the north bridge 14 and the controller 20 integrate to form a chipset. If the controller 20 is an interface card inserted in the computer system 10, then the interface circuit 16 can be a south bridge, and the controller 20 is coupled to the interface circuit 16 through a bus (like a PCI bus).

In order to perform the parity calculation needed by the RAID, the controller 20 also comprises a data access module 18, an operation module 22 and a register module 24. The data access module 18 gains access to the memory 30 by the north bridge 14, and the operation module 22, using a hardware, performs the parity calculation, which includes performing a XOR logic operation on a plurality of input data to generate a corresponding parity data. The register module 24 provides register space needed by the controller 20; for this, the register module 24 can include a status register for temporarily storing status data and a descriptor table pointer register for temporarily storing a descriptor pointer. Also during the operation of the RAID, the central processing unit 12, through an executing driver 28, can control and manage the controller 20, and in the next step, executing through the controller 20 to control the RAID.

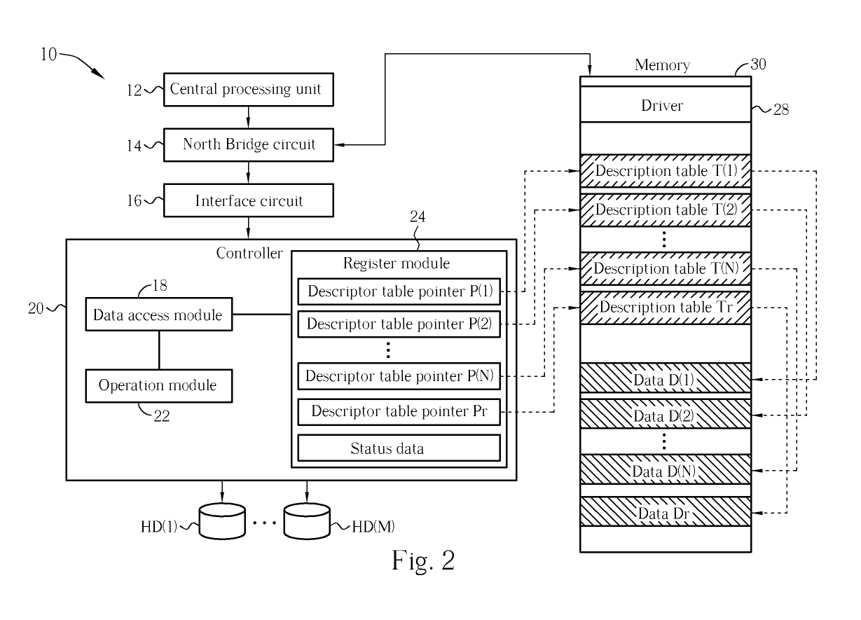

The invention has three ways to utilize the mechanism of descriptor table pointers and description tables of the direct memory access, and the mechanism of status register, to support parity calculations needed by the RAID during operation. The three examples will be explained later. Firstly, please refer to FIG. 2 (at the same time also refer to FIG. 1); FIG. 2 illustrates a diagram of how a hardware parity calculation is implemented by the computer system 10 of FIG. 1 according to the first embodiment. If during the operation of the RAID, the controller 20 needs to perform the hardware parity calculation on data D(1), D(2), to D(N) to generate a corresponding data Dr; then the central processing unit 12 will first prepare the input data D(1) to D(N) of the parity calculation in the memory 30, and through the execution of the driver 28, gathers the description tables T(1) to T(N1) in the memory 30 and writes each descriptor table pointer P(1) to P(N) and Pr into the register module 24 of the controller 20.

In the memory 30, every description table T(n) corresponds to data D(n) for recording a regional address corresponding to the data D(n) stored in the memory 30. To be more specific, each descriptor table pointer T(n) further comprises a plurality of physical region descriptors, not shown in FIG. 2, for describing location of each part of data D(n)in the memory 30. With parts of the data gathered according to their physical region descriptor, the descriptor table pointer T(n) therefore is capable of describing the address region of the whole data D(n) in the memory 30. Description table Tr records the regional address corresponding to data Dr stored in the memory 30. In the register module 24, descriptor table pointers P(1) to P(N) each correspond to the description table T(1) to T(N), and each descriptor table pointer P(n) records the location of the description table T(n) in the memory 30; the descriptor table pointer Pr records the location of the description table Tr in the memory 30.

After the controller 20 receives each descriptor table pointer P(1) to P(N) from the register module 24, the data access module 18 of the controller 20 therefore is capable of accessing each description table T(1) to T(N) of the memory 30 according to the regional address recorded in each descriptor table pointer P(1) to P(N). According to the descriptor table pointers T(1) to T(N), the controller 20 proceeds further by accessing data D(1) to D(N) of the memory 30, and then the hardware of the operation module 22 performs the parity calculation on the data D(1) to D(N) to calculate a corresponding parity data Dr. According to the descriptor table pointer Pr, the data access module 18 is capable of accessing the description table Tr and proceeds to store the parity data Dr calculated by the operation module 22 into the regional address recorded by the description table Tr, hence completing the whole process of the parity calculation.

At the time of performing the parity operation in the above procedure, the central processing unit 12 further controls the accessing process of the status register. In FIG. 2, the controller 20 can also temporarily store a status data S in the register module 24, the register module 24 carrying out the function of status register. After the central processing unit 12 prepares each description table T(1) to T(N), description table Tr and each descriptor table pointer P(1) to P(N), Pr, the status data S of the status register is accessed. The controller 20 begins by receiving data D(1) to D(N) to perform the parity calculation for hardware to calculate the corresponding data Dr, then the parity data Dr is stored back to the memory 30 and the status data S is transmitted back to the central processing unit 12. In other words, the central processing unit 12 accesses and receives a status data response from the controller 20, which means that the controller 20 has completed the hardware parity calculation and stores the parity data Dr back to the memory 30.

As shown in the embodiment in FIG. 2, in order to complete a hardware parity calculation, the register module 24 in the controller 20 temporarily stores N+1 descriptor pointer tables (which are descriptor pointer tables Tr and T(1) to T(N)) and a status data S, which is equivalent to N+1 descriptor pointer table registers and a status register; and the central processing unit 12 accesses N+1 descriptor pointer table registers from the register module 24 of the controller 20. For example, if the controller 20 combines two hard disks to form the RAID 5, when the RAID is accessed, the controller 20 requires two data (N=2) to perform the parity calculation to obtain one parity data. Under these circumstances, the register module 24 of the controller 20 requires to realize three descriptor pointer table registers and a status register. However, in modern implementations, to manage multiple disks, the controller requires a corresponding descriptor table pointer register on each hard disk, hence, the example in FIG. 2 shows that the present invention does not need more descriptor table pointer registers than the current controller technology.

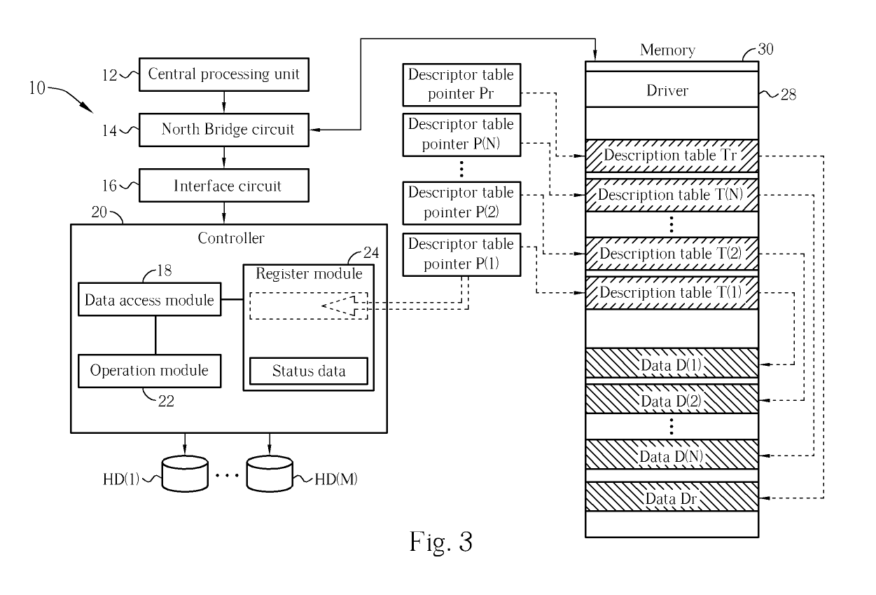

Please refer to FIG. 3 (at the same time also to FIG. 1). FIG. 3 illustrates a diagram of how a hardware parity calculation is implemented in the computer system 10 according to the second embodiment. Similar to the embodiment of FIG. 2, in the embodiment of FIG. 3, when the RAID controller 20 performs a hardware parity calculation on data D(1), D(2) to D(N), the central processing unit 12 will coordinate the execution of the driver 28 and each corresponding descriptor table pointer T(1) to T(N) and Tr and each corresponding descriptor table pointer P(1) to P(N) and Pr will be prepared in the memory 30. The difference in the example of FIG. 3 is that the register module 24 of the controller 20 only requires to realize one descriptor table pointer register and one status register, and each descriptor table pointer P(1) to P(N), Pr sequentially fills the descriptor table pointer register. This also allows the controller 20 to access each data D(1) to D(N) sequentially. For example, when the descriptor table pointer P(1) is being put into the descriptor table pointer register of the controller 20, the controller 20 can access the description table T(1) of the memory 30 according to the descriptor table pointer P(1), and the data D(1) can be accessed according to the description table T(1). The descriptor table pointer P(2) is being filled into the descriptor table pointer register, hence the controller 20 can access the data D(2) via the description table T(2), and so on. After accessing each data D(1) to D(N), the hardware operation module 22 of the controller 20 can perform a parity calculation to obtain a corresponding parity data Dr. In addition, the descriptor table pointer Pr will also be filled into the descriptor table pointer register, and so the controller 20 knows which address in the memory 30 to store the parity data Dr according to the description table Tr.

Similar to the embodiment of FIG. 2, in the embodiment of FIG. 3, the mechanism of the status register can be used as a communication channel for the controller 20 and the software. It also means that the central processing unit 12 can request the controller 20 to access the status data S of the status register. When the controller 20 sends the status data S response to the central processing unit 12, it means that the hardware parity calculation is completed.

As the embodiment of FIG. 3 illustrates, when the parity calculation is performed on N number of data D(1) to D(N), the controller 20 only requires to realize a descriptor table pointer register and a status register, but the descriptor table pointer register is required to perform N+1 number of access to sequentially fill the description table P(1) to P(N) and Pr. For example, when performing the parity calculation on two data, the controller 20 requires a descriptor table pointer and a status register, but a single descriptor table pointer register has to be accessed three times. As the memory space in modern computer systems gets bigger, longer addresses (which has more bits) are needed for addressing data in the memory. Therefore, the modern computer is capable of performing a multiple fill system to utilize the single descriptor table pointer register, such as supporting the direct memory access of ATA 48-bit specification for utilizing the multiple fill system of the descriptor table pointer register to split a longer descriptor table pointer into sequential parts to be filled into the descriptor table pointer register. Therefore, in the example in FIG. 3, neither the circuit architecture nor the control time goes beyond the specification of the modern computer system, and so does not complicate the operation of the computer system.

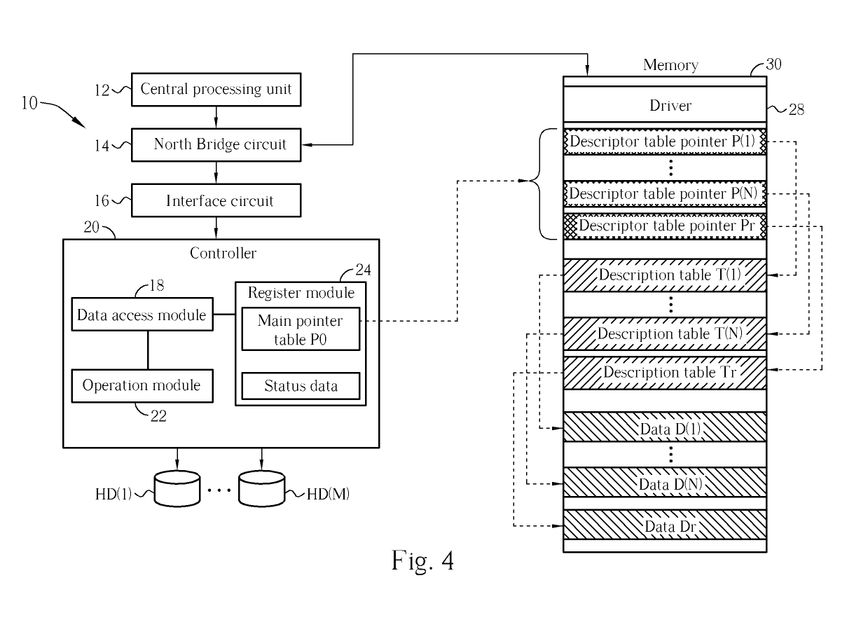

Please refer to FIG. 4. FIG. 4 illustrates a diagram of how a hardware parity calculation is implemented in the computer system 10 according to the third embodiment. Similar to the previous two embodiment, when the controller 20 performs a parity calculation on the data D(1) to D(N), the central processing unit 12 coordinates by executing the driver 28 and prepares the data D(1) to D(N) in the memory 30 and also the corresponding description tables T(1) to T(N) and Tr. Similarly, the central processing unit 12 is also required to prepare the descriptor table pointers P(1) to P(N) and Pr to indicate each descriptor table pointer in the addresses of the memory 30. The difference with the embodiment in FIG. 4 is that the descriptor table pointers P(1) to P(N) and Pr are to be stored in the memory 30 and these descriptor table pointers P(1) to P(N) are recorded as a main pointer table P0 in the address of the controller 30. Thus the main pointer table P0 is filled into the register module 24 of the controller 20. Therefore, in the embodiment of FIG. 4, the register module 24 of the controller 20 only needs to realize a descriptor table pointer register and a status register, and the main pointer table P0 is temporarily stored in the descriptor table pointer register.

In general, when the controller 20 is performing hardware parity calculation on the data D(1) to D(N), the controller 20 accesses each descriptor table pointer P(1) to P(N) and Pr of the memory 30 according to the main pointer table P0 of the descriptor table pointer register. The controller 20 can access data D(1) to D(N) of the memory 30 to perform the hardware parity calculation according to description tables T(1) to T(N); the parity data Dr is calculated and stored in the memory 30 according to descriptor table Tr, hence the hardware parity calculation is completed. Similarly, the time of operation in the above-mentioned process can be controlled by the accessing process of the status register. When the central processing unit 12 accesses the status data S of the status register, the controller 20 performs the hardware parity calculation by utilizing the direct memory access; when the software layer receives the status data S response, it means that the controller 20 has completed the hardware parity calculation and also the parity data Dr is calculated and stored in the memory 30.

In the embodiment of FIG. 4, when the parity calculation is performed on N number of data D(1) to D(N), the controller requires to realize a descriptor table pointer register and a status register, and the descriptor table pointer is accessed once (which is also filled into the main pointer table P0). Relatively, the descriptor table pointers P(1) to P(N) and Pr are each to be filled (to be stored) into the memory 30. Equivalently, each descriptor table pointer P(1) to P(N) and Pr of the memory 30 is viewed as each table entry of a description table, and the main pointer table P0 can direct the controller 20 to access each descriptor table pointer of an equivalent description table. Therefore, the embodiment in FIG. 4 can be realized with the mechanism of the descriptor table pointer and the description table under the direct memory access, and hence does not increase complication.

In comparison to FIG. 2 and FIG. 3, the embodiment in FIG. 4 has a higher efficiency, as access to the register module 24 is least. When the parity calculation is performed on N number of data D(1) to D(N), the embodiment in FIG. 2 needs to perform N+1 descriptor table pointer accesses to the register module 24 (which also means filling each descriptor table pointer register into N+1 descriptor table pointer registers), the embodiment in FIG. 3 also needs to perform N+1 descriptor table pointer accesses to the register module 24 (to sequentially perform N+1 accesses on one descriptor table pointer register). The embodiment in FIG. 4 only requires performing the descriptor table pointer access once to the register module 24 of the controller 20 (filling in a main pointer table P0). Although during the parity calculation in FIG. 4, in addition, each descriptor table pointer P(1) to P(N) and Pr is also accessed from the memory 30, and since accessing the memory 30 is faster and more efficient than accessing the register module 24, the access process of the register module 24 is reduced and the time spent for the hardware parity calculation is shortened.

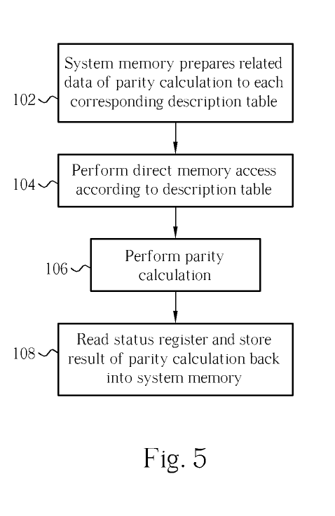

The embodiment of above-mentioned process can be seen in FIG. 5. Please refer to FIG. 5 (at the same time refer to FIG. 1). FIG. 5 illustrates a flowchart of the computer system 10 implementing the mechanism of direct memory access to perform the hardware parity calculation. The steps are as:

Step 102: During the operation of the RAID, when parity calculation is performed on each input data D(1) to D(N), the central processing unit 12 coordinates with the execution of the software driver 28by preparing a description table corresponding to each data, and stores these tables in the memory 30. In addition, the related descriptor table pointers (or the main pointer table in FIG. 4) are stored in the register module 24 of the controller 20.

Step 104: Utilize the mechanism of descriptor table pointers and description tables of the direct memory access, directly obtain the data D(1) to D(N) needed by the parity calculation from the memory 30.

Step 106: Perform the hardware parity calculation by the operation module 22 of the controller 20.

Step 108: Utilize the mechanism of the status register of the direct memory access, so that the controller 20 stores the result of the parity calculation (which is data Dr) back into the memory 30. When the central processing unit 12 accesses the status data response of the controller 20 on the software level of the driver 28, it represents that the controller 20 has completed the hardware parity calculation, and the result of the parity calculation is stored back into system memory (which is the memory 30).

In conclusion, the invention utilizes the mechanism of direct memory access to realize a simple hardware parity calculation in the RAID controller, in order to service the parity calculation during the operation of the RAID. In comparison to the prior art realized by the software, the invention utilizes hardware to perform the parity calculation, thus the parity calculation of the invention reduces the workload of the central processing unit, and hence increases the efficiency of the whole computer system. Also in comparison with the prior art implemented by hardware, the invention utilizes the system memory and the related circuit (such as the north bridge) to support the memory resources needed for the parity calculation. As the simplified hardware of the controller in the invention does not require a special memory, and thus, it has low cost, low resource consumption and low heat output, and furthermore it is capable of not only being installed as an interface card, but also being built into a motherboard or a chipset to suit small and slim computers. Furthermore, the invention utilizes the mechanism of the status register of the direct memory access to communicate with the controller and the software, which creates less interference for the central processing unit. In the prior arts, after either the hardware or software parity calculation, an interrupt is sent to notify the central processing unit. At this moment, the central processing unit uses up much of its efficiency to handle the interrupt. In comparison, in the invention uses the mechanism of the status register to realize a communication channel for the central processing unit and the controller, and thus, there is less work for the central processing unit when handling the interrupt.

Also, other than the parity calculation needed by the RAID, by just changing the hardware function of the operation module 22, the invention can utilize the direct memory access to perform other calculations. For example, RAID 2 needs to perform a Hamming coding on the data. If the hardware operation function of the operation module 22 is expanded to Hamming coding, then the invention can also utilize the system memory to support the hardware Hamming coding, such that the simplified components of the RAID controller are capable of carrying out the Hamming coding.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system, comprising:
a central processing unit;
a memory;
a north bridge circuit coupled between the central processing unit and the memory; and
a controller coupled to the north bridge circuit, the controller comprising:
a data access module for accessing at least two input data from the memory by the north bridge circuit; and
an operation module for performing a logic operation on the input data to generate a parity data, wherein the parity data is stored in the memory by the north bridge circuit.

2. The computer system of claim 1, wherein the controller further comprises:
a register module for storing a status data, wherein the logic operation is performed while the central processing unit accesses the status data, and the parity data is stored in the memory by the north bridge circuit before the central processing unit receives the status data.

3. The computer system of claim 2, wherein at least one descriptor table pointer is stored in the register module by the central processing unit, and the input data is accessed from the memory by the data access module according to the descriptor table pointer.

4. The computer system of claim 3, wherein at least one description table is utilized for recording an address region corresponding to the input data stored in the memory, and the description table is accessed according to the descriptor table pointer, and the input data is accessed in the memory according to the description table.

5. The computer system of claim 2, wherein the descriptor table pointers are sequentially stored in the register module by the central processing unit, each descriptor table pointer records a correspondingly address region in the description table of the memory, and each description table records an address corresponding to the input data of the memory.

6. The computer system of claim 5, wherein the central processing unit stores every descriptor table pointer in the register module and accesses the correspondingly input data in the memory to access the input data from the memory.

7. The computer system of claim 2, wherein the memory stores a plurality of descriptor table pointers and a plurality of description tables, each description table records a correspondingly input data in the memory, and each descriptor table pointer records a correspondingly address in the memory.

8. The computer system of claim 7, wherein a total descriptor table pointer including all the descriptor table pointers is stored in the register module by the central processing unit, the total descriptor table pointer records each pointer in the address of the memory, and the data access module first accesses each descriptor table pointer in the memory according to the total descriptor table pointer and accesses each description table according to each descriptor table pointer to accesses the input data from the memory according to each description table.

9. The computer system of claim 1, further comprising:
a storage device coupled to the controller, wherein the controller transfers each input data and the correspondingly parity data to the storage device.

10. A parity calculating method of a computer system, the computer system having a memory and a register module, comprising:
accessing at least two input data from the memory;
storing a status data in the register module;
accessing a status data, and performing a logic operation of the input data to generate a correspondingly parity data; and
storing the parity data in the memory before the data access module receives status data.

11. A method of claim 10 further comprising:
storingat least one description table in the memory, wherein each description table records an address region corresponding to the input data in the memory; and
storing at least one descriptor table pointer in the register module, wherein each descriptor table pointer records a correspondingly table address in the memory; and
accessing each description table according to a descriptor table pointer and accessing the input data according to each description table accessing the input data from the memory.

12. A method of claim 10 further comprising:
storing a plurality of descriptor table pointers and a plurality of description tables in the memory, wherein each description table records an address region individually corresponding to the input data, and
each descriptor table pointer records an address corresponding to one description table of the memory; and
storing a total descriptor table pointer in the register module, wherein the total descriptor table pointer records the address of each description table of the memory; and
wherein each descriptor table pointer is accessed by the total descriptor pointer to access correspondingly descriptor table, and the input data is accessed from the memory according to each descriptor table respectively.

13. A method of claim 10 further comprising:
storing a descriptor table pointer in the register module at different times in a sequence, wherein each descriptor table pointer records an address corresponding to the descriptor table of the memory, and each description table records an address region corresponding to the input data of the memory; and
wherein the input data is accessed from the memory according to the descriptor table pointer and the descriptor table after the descriptor table pointer recording in the register.
